(19) United States
(12) Patent Application Publication
(10) Pub. No.: US 2005/0099909 A1
(43) Pub. Date: May 12, 2005

(54) Method of improving the readability of a DVD control data zone

(75) Inventor: Yi-Chung Lee, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/981,577

(22) Filed: Nov. 5, 2004

(30) Foreign Application Priority Data
Nov. 6, 2003 (TW) 92131142

(51) Int. Cl. G11B 5/09

(52) U.S. Cl. 369/47.27; 369/59.25; 369/124.01

(57) ABSTRACT

A method of improving the readability of a DVD control data zone is disclosed. Firstly, an optical drive reads the control data zone and sends the disc information of the control data zone to a buffer in order to decode the information. If the decoding process fails, the disc information is corrected by a number of known bit values, and the corrected disc information is decoded again.

This application claims the benefit of Taiwan application Serial No. 92131142, filed Nov. 6, 2003, the subject matter of which is incorporated herein by reference.

### BACKGROUND OF THE INVENTION

1. Field of the Invention

The invention relates in general to a method of reading a DVD optical disc, and more particularly to a method of improving the readability of a DVD control data zone.

2. Description of the Related Art

FIG. 1 is a schematic illustration showing a typical DVD optical disc format. The format includes a lead-in zone 20, a data zone 30 and a lead-out zone 40. The lead-in zone 20 and the lead-out zone 40 identify the start of the data zone, while the data zone 30 is a zone, into which the user data are written.

Generally speaking, when the optical drive is started up, the control data zone is read from the lead-in zone 20 on the DVD optical disc first, and the read information is stored into the memory of the optical drive. Therefore, after the optical drive is started up, the data zone allocation on the DVD optical disc can be retrieved according to the information in the memory. In other words, the information in the memory can serve as an index for the optical drive to read the optical disc data.

The control data zone of the lead-in zone 20 is composed of 192 repeated ECC (Error Corrected Code) blocks, each of which has a unit of 16 physical sectors. That is, the control data zone is composed of 3072 physical sectors. Usually, the control data zone has a unit of one control data block 80. The control data block 80 has a format as shown in FIG. 2. The control data block 80 includes physical format information 50, disc manufacturing information 60 and content provider information 70. Because the specification of the current DVD optical disc does not specify the information 60 and 70 too much, the optical drive skips the information 60 and 70 when it reads the control data block.

The physical format information 50 totally has 2048 bytes, each of which represents the content shown in FIG. 3. The content includes the disc information of the disc category and version number, the disc size and maximum transfer rate, the disc structure, the recording density, the data zone allocation, and the like. 100061 Taking Byte 1 as an example, its content represents the disc size and maximum reading speed. When its bits b0 to b3 are set as 0000, it represents that the maximum transfer rate of the disc is 2.52 Mbits/s. If the bits b0 to b3 are set as 0010, the maximum transfer rate is 10.08 Mbits/s. When the bits b4 to b7 are set as 0000, it represents that the disc size is 120 mm. The associated specifications of other bytes may be found in the DVD specification. It is to be noted that the current DVD specification only specifies the contents of parts of bytes of the physical format information 50, and the bytes that are not specified are all reserved and set to 0.

Because the information of the control data zone of the lead-in zone 20 is a very important portion of the DVD optical disc, it is difficult to read the disc if the control data block is scratched or poorly written. In terms of the current optical driver, it will switch to another control data block if one control data block cannot be successfully read. However, if the writing quality of the overall DVD optical disc is poor, the possibility of unsuccessful reading is very high. Thus, it is necessary to provide a method of reading the control data zone more effectively in order to solve the above-mentioned problem of the optical drive.

### SUMMARY OF THE INVENTION

It is therefore an object of the invention to provide a method of improving the readability of a DVD control data zone so as to solve the problem of difficult reading owing to the scratched or poorly written control data zone.

The invention achieves the above-identified object by providing a method of improving the readability of a DVD control data zone. Firstly, an optical drive reads the control data zone and sends the disc information of the control data zone to a buffer in order to decode the information. If the decoding process fails, the disc information is corrected by known bit values, and the corrected disc information is decoded again.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a DVD optical disc format.

FIG. 2 is a schematic illustration showing a control data zone.

FIG. 3 is a schematic illustration showing a physical format information zone.

FIG. 4 is a flow chart showing the method of improving the readability of a DVD control data zone in the invention.

FIGS. 5A and 5B are schematic illustrations showing a wobble on an optical disc.

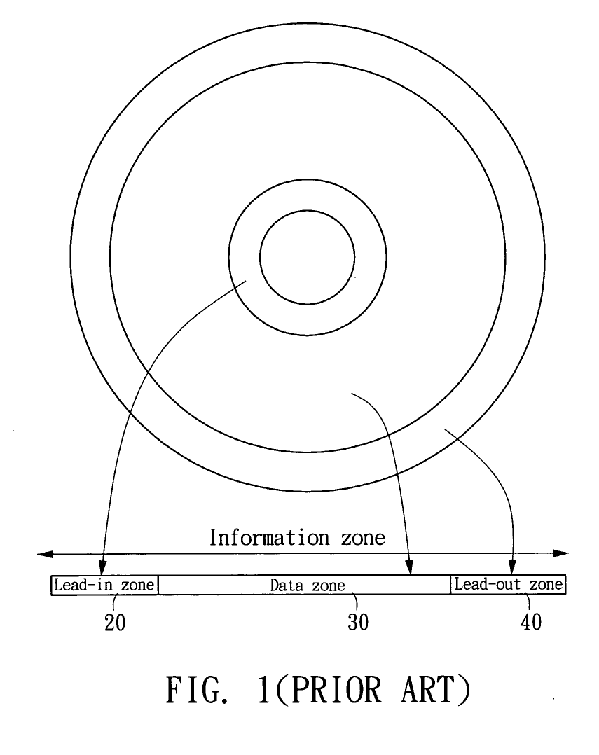

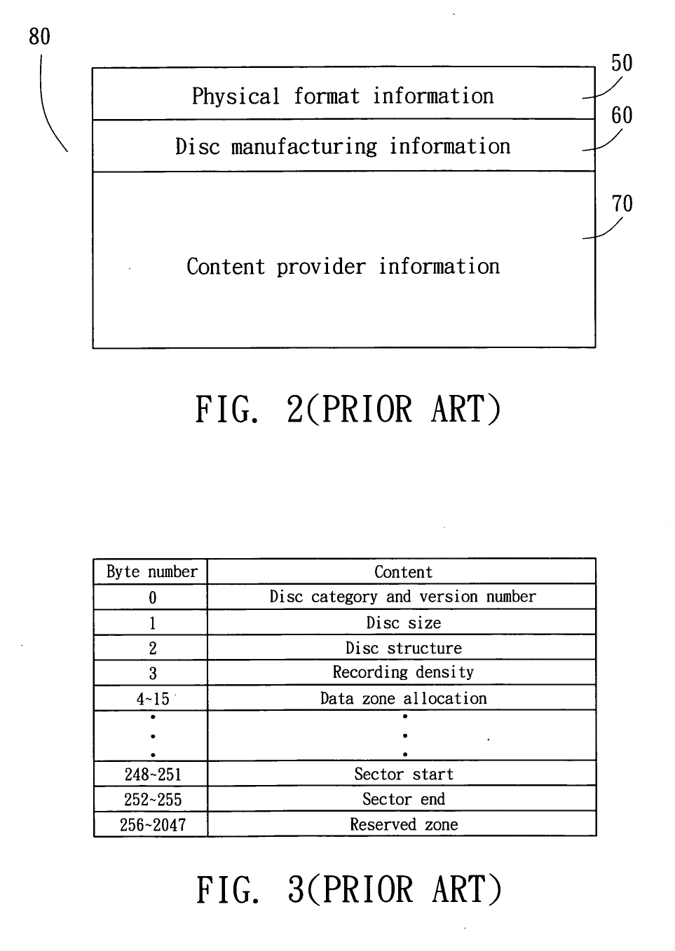

### DETAILED DESCRIPTION OF THE INVENTION

The information of the control data zone is a very important portion in the DVD optical disc, and it is difficult to read the information if the control data zone is scratched or poorly written. In order to overcome the above-mentioned problem, the invention discloses an improved method of reading a DVD control data zone.

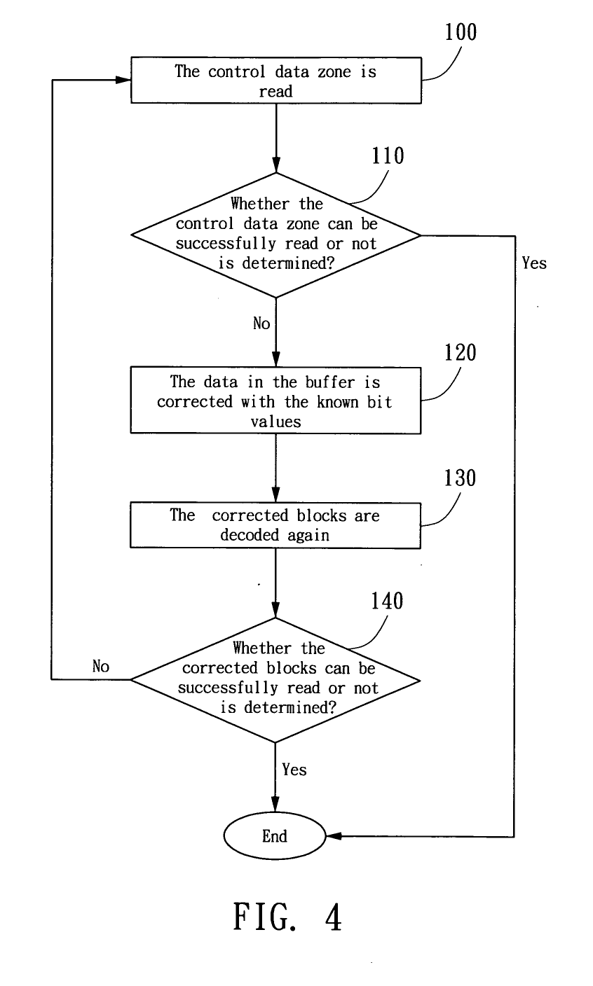

FIG. 4 is a flow chart showing the method of improving the readability of a DVD control data zone in the invention. The method includes the following steps.

In the step 100, the control data zone is read.

In the step 110, it is determined whether or not the control data zone can be successfully read. If yes, the procedure is ended. If not, the procedure goes to the step 120.

In the step 120, the buffer data are corrected—with the known bit values.

In the step 130, the corrected blocks are decoded again.

In the step 140, it is determined whether or not the control data zone can be successfully read. If yes, the procedure is ended. If not, the procedure returns to the step 100 and the control data zone is read again.

Firstly the optical drive reads the control data zone (in the step 100), and stores the read information from the control data zone into the buffer of the optical drive for the subsequent decoding operation. Next, it is determined whether or not the optical drive can successfully read the information of the control data zone (in the step 110). If yes, it represents that the optical drive can successfully decode the information of the control data zone. If not, it represents that the optical drive cannot correctly decode the information of the control data zone, and the optical drive cannot recognize the contents in the optical disc.

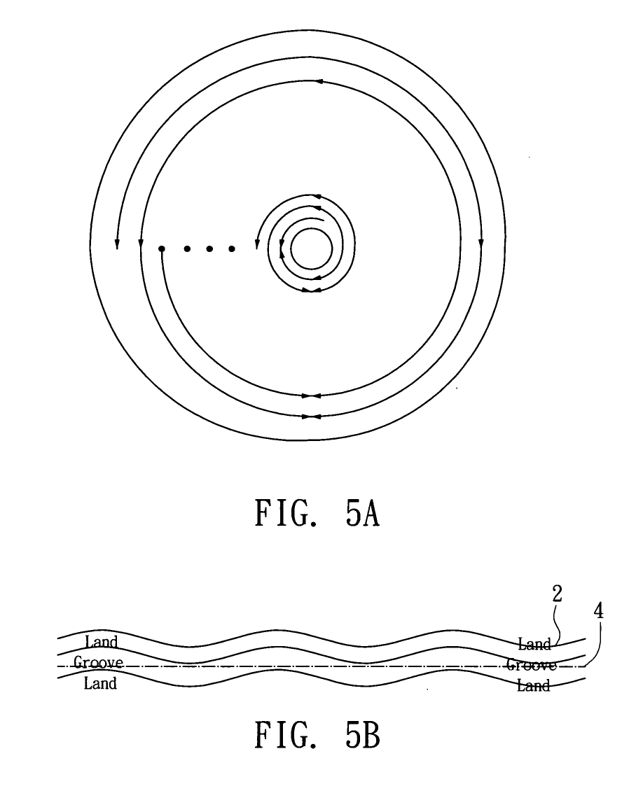

In the following procedure, the characteristic of the DVD optical disc is utilized for fulfilling the invention. Generally, the tracks of the DVD optical disc are manufactured to have a shape of a continuous spiral groove as shown in FIG. 5A. Taking the DVD+R/RW optical disc as an example, a high-frequency phase modulation signal having a deviated shape of sine curve is additionally stored in the track 4, as shown by the symbol 2 in FIG. 5B. Usually, the modulation signal is called as a wobble.

The wobble signal includes the addressing information of the optical disc, which is referred to as the ADIP (Address-in-Pregroove). The ADIP includes the information of the disc format and the disc track allocation, and all the information written into the control data zone of the optical disc has to be corresponding to the ADIP. Furthermore, the ADIP also has the physical format data zone, the size of which is 256 bytes. The physical format data zone of ADIPis slightly different from the physical format information of the control data zone. Such as the byte 0, byte 1 and bytes 4 to 15 of the physical format information. Therefore, the physical format information of ADIP and the physical format information of the control data zone are almost the same.

Hence, by utilizing the above-mentioned characteristic of the DVD+R/RW optical disc, the data in the buffer can be corrected according to the bit values retrieved from the ADIP (in the step 120). Then, the corrected blocks are decoded again (in the step 130). If the blocks can be read successfully, the procedure is ended. If not, the control data zone is read again (in the step 140).

In addition, because the bits, which are not specified, in the physical format information have a default value of 0, a portion of the bit values in the physical format information can be known in advance. The invention also utilizes this characteristic to correct the data in the buffer according to these known bit values (0) in the step 120, thereby increasing the successful possibility of the subsequent decoding. The method according to the invention can be applied to all DVD-format optical discs (e.g., DVD-ROM, DVD-R/RW, DVD+R/RW, DVD-RAM, and the like).

Hence, one advantage of the invention is to utilize the characteristic of the DVD optical disc to solve the problem of being incapable of successfully reading the control data zone in the optical drive.

Furthermore, another advantage of the invention is to correct the control data zone according to the retrieved ADIP information. Thus, the readability of the optical drive can be effectively enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of improving the readability of a control data zone, applied in an optical drive, the method comprising the steps of:
reading the control data zone, and sending disc information of the control data zone to a buffer for decoding;
correcting the disc information with a plurality of known bit values when the decoding step fails; and
decoding the corrected disk information again.

2. The method according to claim 1, wherein the buffer is disposed in the optical drive.

3. The method according to claim 1, wherein part of the bit values are retrieved from Address-in-Pregroove (ADIP).

4. The method according to claim 3, wherein the bit values retrieved from the ADIP are the same as a part of a plurality of bit values of the control data zone.

5. The method according to claim 1, wherein a part of the bit values of control data zoneare reserved and set to 0.

6. A method of improving the readability of a control data zone, applied in an optical drive, the optical drive reading a control data zone, sending disc information of the control data zone to a buffer for decoding, the method characterized in that the disc information is corrected by a plurality of known bit values when the decoding step fails, and the corrected disc information is decoded again.

7. The method according to claim 6, wherein the buffer is provided by the optical drive.

8. The method according to claim 6, wherein the bit values are retrieved from Address-in-Pregroove (ADIP).

9. The method according to claim 8, wherein the bit values retrieved from the ADIP are the same as a part of a plurality of bit values of the control data zone.

10. The method according to claim 6, wherein a part of the bit values of the control data zone are reserved and set to 0.
